(19) United States
(12) Patent Application Publication
(10) Pub. No.: US 2025/0252803 A1
(43) Pub. Date: Aug. 7, 2025

(54) MONEY HANDLING APPARATUS, MONEY HANDLING SYSTEM, AND CONTROL METHOD

(71) Applicant: GLORY LTD., Himeji-shi (JP)

(72) Inventors: Koshi YAMAMOTO, Himeji-shi (JP); Yuki FURUYAMA, Himeji-shi (JP); Akito KURODA, Himeji-shi (JP); Jun ARIKATA, Himeji-shi (JP)

(73) Assignee: GLORY LTD., Himeji-shi (JP)

(21) Appl. No.: 19/185,074

(22) Filed: Apr. 21, 2025

Related U.S. Application Data
(63) Continuation of application No. PCT/JP2023/037630, filed on Oct. 18, 2023.

(30) Foreign Application Priority Data
Oct. 24, 2022 (JP) 2022-169677

(51) Int. Cl. G07D 11/20; G07D 11/60

(52) U.S. Cl. CPC G07D 11/20; G07D 11/60

(57) ABSTRACT

A money handling apparatus includes: an information output device configured to output information by which whether a user is a customer or a staff member can be determined; and a controller configured to selectively execute a first control mode for a case where the user is the customer and a second control mode for a case where the user is the staff member, based on the information from the information output device.

### CROSS-REFERENCE TO RELATED APPLICATIONS

This application is a continuation of International Application No. PCT/JP2023/037630 filed on Oct. 18, 2023, entitled “CURRENCY PROCESSING DEVICE, CURRENCY PROCESSING SYSTEM, AND CONTROL METHOD”, which claims priority under 35 U.S.C. Section 119 of Japanese Patent Application No. 2022-169677 filed on Oct. 24, 2022, entitled “CURRENCY PROCESSING DEVICE, CURRENCY PROCESSING SYSTEM, AND CONTROL METHOD”. The disclosures of the above applications are incorporated herein by reference.

### BACKGROUND OF THE INVENTION

### Field of the Invention

The present invention relates to a money handling apparatus and a money handling system that handle money such as banknotes and coins, and a control method for the money handling apparatus.

### Description of Related Art

To date, at a financial institution such as a bank, in addition to ATMs to be operated by customers, a money handling apparatus (cashier machine) for storing and managing money is placed in a working area. Depositing and dispensing money into and from the money handling apparatus is performed by a staff member of the financial institution. Japanese Laid-Open Patent Publication No. 2018-206309 describes such a type of money handling apparatus.

Meanwhile, in recent years, financial institutions have been reducing their staff, and the number of staff members assigned to each branch has been decreasing. For this reason, in branches that are short of staff, there is a need for an operation in which the above-described money handling apparatus (cashier machine) is placed in a lobby or the like and not only staff members but also customers are allowed to deposit and dispense money into and from the money handling apparatus.

However, if this operation is carried out, customers may have problems with smoothly depositing and dispensing money, due to being unfamiliar with operating the money handling apparatus. In addition, since the money that customers bring in from outside is deposited directly into the money handling apparatus, there is also a possibility that problems that are less likely to occur when a staff member deposits money will often occur.

### SUMMARY OF THE INVENTION

A first aspect of the present invention is a money handling apparatus including: an information output device configured to output information by which whether a user is a customer or a staff member can be determined; and a controller configured to selectively execute a first control mode for a case where the user is the customer and a second control mode for a case where the user is the staff member, based on the information from the information output device.

In the money handling apparatus according to this aspect, when the user is the customer, the first control mode, which is suitable for customers, is executed, and when the user is the staff member, the second control mode, which is suitable for staff members, is executed. Therefore, it is possible to smoothly and appropriately deal with money handling from either user.

The information output device can include an interface configured to accept an operation from the user, and the controller can be configured to determine whether the user is the customer or the staff member, based on information from the interface, and selectively execute the first control mode and the second control mode, based on a result of the determination.

Alternatively, the information output device can include a date/time output module configured to output information about a date and time, and the controller can be configured to selectively execute the first control mode and the second control mode, based on the information about the date and time outputted from the date/time output module.

Alternatively, the information output device can include a camera configured to output an image of the user, and the controller can be configured to determine whether the user is the customer or the staff member, based on the image of the user outputted from the camera, and selectively execute the first control mode and the second control mode, based on a result of the determination.

The controller can be configured to make control for money handling differ between the first control mode and the second control mode.

In this case, the controller can be configured to make a money transport speed in the first control mode lower than in the second control mode.

Alternatively, the controller can be configured to make a level of recognition of money in the first control mode higher than in the second control mode.

A second aspect of the present invention is directed to a money handling system. The money handling system according to this aspect includes: an information output device configured to output information by which whether a user is a customer or a staff member can be determined; and a controller configured to selectively execute a first control mode for a case where the user is the customer and a second control mode for a case where the user is the staff member, based on the information outputted by the information output device.

A third aspect of the present invention is directed to a control method in a money handling apparatus. The control method according to this aspect includes: acquiring information by which whether a user is a customer or a staff member can be determined; and selectively executing a first control mode for a case where the user is the customer and a second control mode for a case where the user is the staff member, based on the acquired information.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 is a plan view schematically showing an example of the layout of an establishment according to an embodiment;

FIG. 2 is a perspective view showing a configuration of a money handling apparatus according to the embodiment;

FIG. 3 is a schematic diagram showing an internal configuration of a banknote handling assembly according to the embodiment;

FIG. 4 is a block diagram showing a main configuration of the money handling apparatus according to the embodiment;

FIG. 5 is a flowchart showing a setting process for a control mode according to the embodiment;

FIG. 6 is a flowchart showing a process of determining whether a user is a customer or a staff member, according to the embodiment;

FIG. 7A and FIG. 7B are each a diagram showing an example of an inquiry screen according to the embodiment;

FIG. 8 is a flowchart showing a process of determining whether a user is a customer or a staff member, according to the embodiment;

FIG. 9 is a flowchart showing a process of determining whether a user is a customer or a staff member, according to the embodiment;

FIG. 10 is a flowchart showing a process switched between a first control mode and a second control mode according to the embodiment;

FIG. 11A is a diagram showing a configuration example of a menu screen when a display form is set to a second display form, according to the embodiment;

FIG. 11B is a diagram showing another configuration example of a menu screen when the display form is set to a first display form, according to the embodiment;

FIG. 12A is a diagram showing a configuration example of a deposit screen when the display form is set to the second display form, according to the embodiment;

FIG. 12B is a diagram showing a configuration example of a deposit screen when the display form is set to the first display form, according to the embodiment;

FIG. 13 is a flowchart showing a process switched between the first control mode and the second control mode according to the embodiment;

FIG. 14A is a diagram showing a configuration example of an error screen when an error occurs in the first control mode, according to the embodiment;

FIG. 14B is a diagram showing a configuration example of an error screen when an error occurs in the second control mode, according to the embodiment;

FIG. 15 is a flowchart showing a process switched between the first control mode and the second control mode according to the embodiment;

FIG. 16 is a flowchart showing a process switched between the first control mode and the second control mode according to the embodiment;

FIG. 17 is a flowchart showing a process switched between the first control mode and the second control mode according to the embodiment;

FIG. 18 is a flowchart showing a process switched between the first control mode and the second control mode according to the embodiment;

FIG. 19A and FIG. 19B are each a diagram showing a configuration of a banknote depositing/dispensing unit according to Modification 1;

FIG. 20 is a flowchart showing a process switched between the first control mode and the second control mode according to Modification 1; and

FIG. 21 is a block diagram showing a main configuration of a money handling apparatus according to Modification 2.

It should be noted that the drawings are solely for description and do not limit the scope of the present invention by any degree.

### DETAILED DESCRIPTION

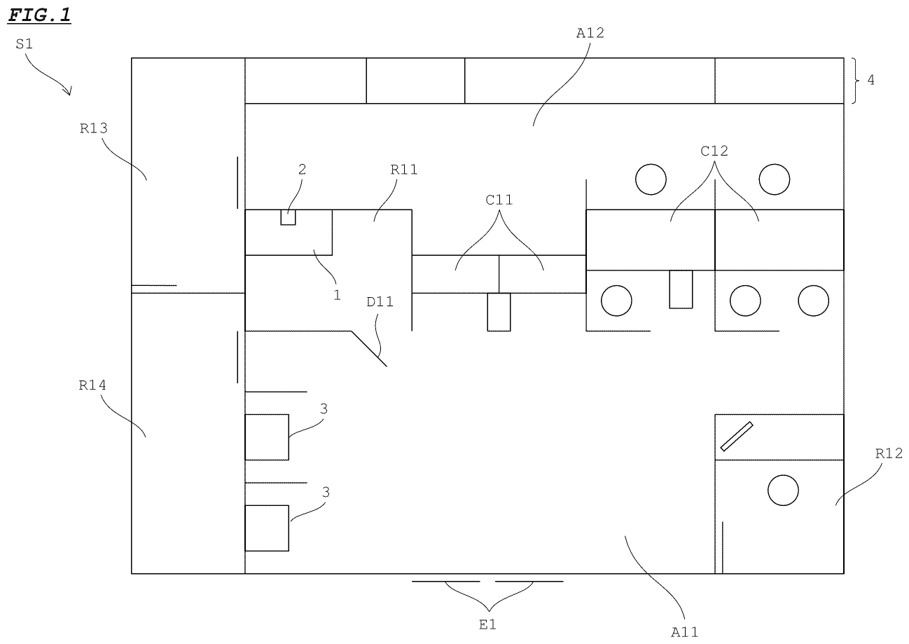

FIG. 1 is a plan view schematically showing an example of the layout of an establishment S1.

The establishment S1 is, for example, a branch of a bank. The store establishment S1 is divided into a lobby area A11 and a working area A12 by counters C11 and C12. The lobby area A11 is an area where customers who enter through an entrance E1 stay. The working area A12 is an area where staff members perform work. A cashier system 4 including a money handling assembly other than a money handling apparatus 1 is installed at the back of the working area A12. Staff members serve customers via the counters C11 and C12 and perform cash transactions. In addition, the staff members access the cashier system 4 as necessary to manage cash, etc.

A room R11 for customers to perform a cash transaction directly without a staff member is connected to the lobby area A11. The money handling apparatus 1 for performing a transaction process such as large deposits is installed in the room R11. For example, proceeds from sales, etc., of customers are deposited into the money handling apparatus 1. In addition, a camera 2 that overlooks the front of the money handling apparatus 1 and the inside of the room R11 is installed in the room R11. When a customer directly makes a large deposit or the like, the customer enters the room R11, closes a door D11, and performs a transaction process on the money handling apparatus 1.

On the money handling apparatus 1, a staff member also performs predetermined processes such as depositing, dispensing, loading, and collection. In this case, the staff member moves from the working area A12 through rooms R13 and R14 to the lobby area A11, enters the room R11, and performs a process on the money handling apparatus 1. As described above, the money handling apparatus 1 is shared by customers and staff members.

In addition, two ATMs 3 are installed in the lobby area A11, and a room R12 for customers to take remote consultation via a terminal is connected to the lobby area A11. The ATMs 3 are used by customers to perform depositing or dispensing of a small amount of money, etc.

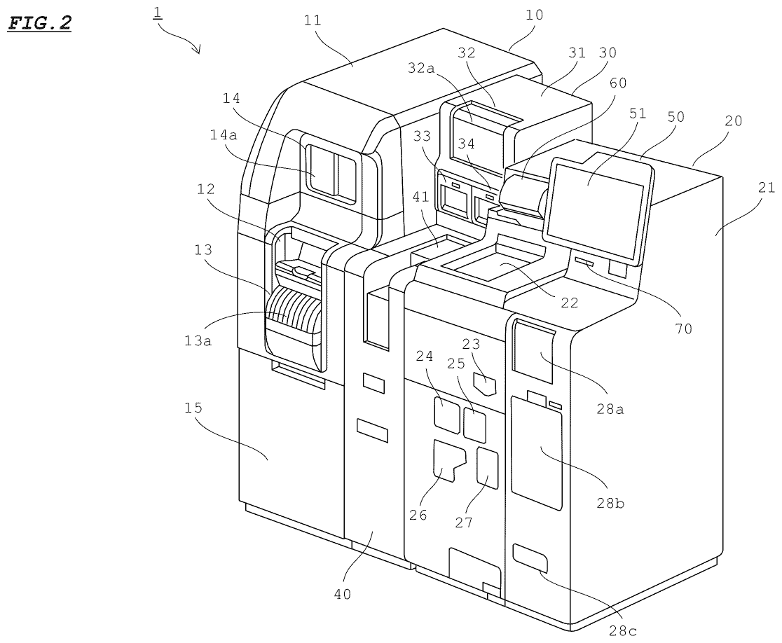

FIG. 2 is a perspective view showing a configuration of the money handling apparatus 1.

The money handling apparatus 1 includes a banknote handling assembly 10, a coin handling assembly 20, a deformed coin/commemorative coin handling assembly 30, an unfit note handling assembly 40, an operation terminal 50, a printer 60, and a card reader 70.

The operation terminal 50, the banknote handling assembly 10, the coin handling assembly 20, the deformed coin/commemorative coin handling assembly 30, the unfit note handling assembly 40, the printer 60, and the card reader 70 are connected to each other by a communication cable (not shown), for example. This connection may be made by a wireless method rather than a wired method.

The banknote handling assembly 10 includes a housing 11 that forms an outer shell. On the front surface of the housing 11, an inlet 12 and an outlet 13 are provided at a center portion so as to be aligned vertically, and a bundle outlet 14 is provided at an upper portion. The outlet 13 is opened and closed by a shutter 13a that opens and closes vertically, and the bundle outlet 14 is opened and closed by a shutter 14a that opens and closes horizontally. Loose notes are inserted into the inlet 12, and loose notes are dispensed into the outlet 13. Bundled banknotes are dispensed into the bundle outlet 14. Bundled banknotes are produced by bundling up a predetermined number (e.g., 100) of banknotes with a strip. Furthermore, on the front surface of the housing 11, a door 15 is provided at a lower portion.

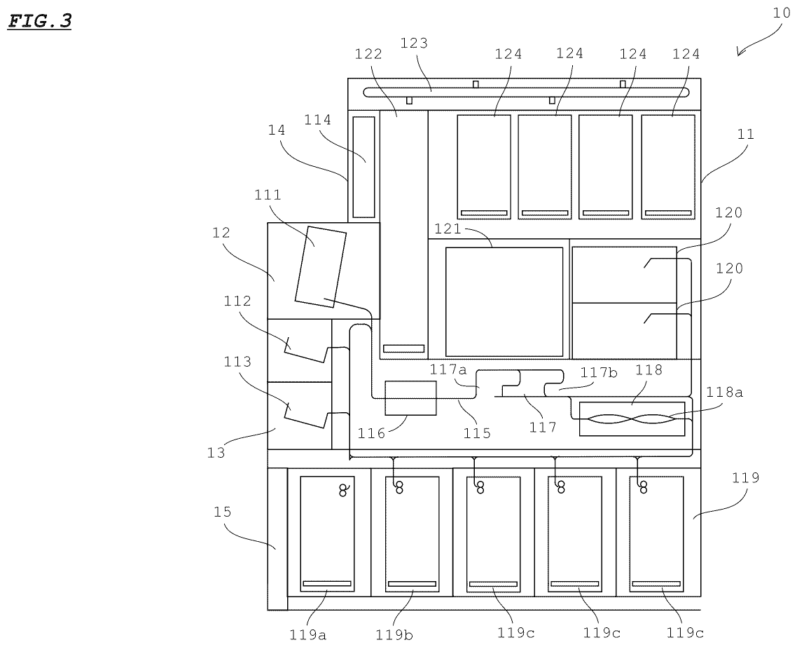

The internal structure of the banknote handling assembly 10 will be described later with reference to FIG. 3.

The coin handling assembly 20 includes a housing 21 that forms an outer shell. On the upper surface of the housing 21, an inlet 22 is provided. On the left side of the front surface of the housing 21, a deposit reject port 23, a loose coin collection box 24, a return box 25, a dispensing box 26, and a bag take-up chute 27 are provided. On the right side of the front surface of the housing 21, a wrapped coin outlet 28a, a wrapped coin collection box 28b, and an external ejection port 28c are provided. The loose coin collection box 24, the return box 25, the dispensing box 26, the bag take-up chute 27, and the wrapped coin collection box 28b can be freely pulled out frontward from the housing 21. Inside the coin handling assembly 20, a feeding mechanism, a transport unit, a recognition unit, a loose coin temporary storage unit, a loose coin storage unit, a wrapped coin production unit, and a wrapped coin storage unit that are not shown are provided.

In depositing, loose coins are inserted into the inlet 22. The inserted loose coins are fed out one by one by the feeding mechanism, then transported by the transport unit, and recognized by the recognition unit placed at the transport unit. Coins recognized as not being a normal coin are returned to the deposit reject port 23 by the transport unit, and coins recognized as being a normal coin are temporarily stored in the loose coin temporary storage unit by the transport unit. The loose coins in the loose coin temporary storage unit are stored in the loose coin storage unit when an approval operation is performed, and are returned to the return box 25 when a return operation is performed. When no more loose coins can be stored in the loose coin storage unit, the excess loose coins are stored in the loose coin collection box 24.

In dispensing, the loose coins in the loose coin storage unit are dispensed to the dispensing box 26. In the case of dispensing and bagging loose coins, a cash bag is connected to the bag take-up chute 27 pulled out from the housing 21, and the loose coins in the loose coin storage unit are ejected to the cash bag through the bag take-up chute 27.

In the case of producing wrapped coins, loose coins inserted into the inlet 22 are sent to the wrapped coin production unit. In the wrapped coin production unit, wrapped coins are produced by wrapping a plurality of (e.g., 50) loose coins, which are stacked in a bar shape, with a wrapping material. The produced wrapped coins are stored in the wrapped coin storage unit or dispensed to the wrapped coin outlet 28a. When a large number of wrapped coins are to be dispensed, the external ejection port 28c is used. In this case, a cash box or the like for receiving wrapped coins is placed below the external ejection port 28c. When no more wrapped coins can be stored in the wrapped coin storage unit, the excess wrapped coins are stored in the wrapped coin collection box 28b.

The deformed coin/commemorative coin handling assembly 30 includes a housing 31 that forms an outer shell. An opening 32 is provided at an upper portion of the front surface of the housing 31. The opening 32 is opened and closed by a shutter 32a. Two storage boxes 33 and 34 that can be pulled out are provided at a lower portion of the front surface of the housing 31. For example, commemorative coins are stored in the storage box 33, and deformed coins are stored in the storage box 34.

In depositing, the shutter 32a is opened, and a deformed coin or commemorative coin is placed at a placement position in the opening 32. Then, the shutter 32a is closed, and an image of the placed deformed coin or commemorative coin is taken by a camera within the housing 31. The taken image is displayed on the operation terminal 50. While referring to the displayed image, a staff member inputs information such as the denomination of the deformed coin or the commemorative coin into the operation terminal 50 and performs a confirmation operation. Accordingly, the deformed coin or commemorative coin is stored in either one of the storage boxes 33 and 34, and the inputted information such as the denomination and the image are stored in a storage of the operation terminal 50 in association with each other.

The unfit note handling assembly 40 includes a depositing unit 41. An unfit note inserted into the depositing unit 41 is taken into the unfit note handling assembly 40, and an image of the unfit note is acquired by a line scanner or the like. The taken image is displayed on the operation terminal 50. While referring to the displayed image, the staff member inputs information such as the denomination of the unfit note into the operation terminal 50 and performs a confirmation operation. Accordingly, the unfit note is stored in a storage unit, and the inputted information such as the denomination and the image are stored in the storage of the operation terminal 50 in association with each other.

The operation terminal 50, the printer 60, and the card reader 70 are placed at an upper portion of the coin handling assembly 20. The operation terminal 50 is provided with an interface 51 on the front surface thereof. The interface 51 displays a screen for operations and accepts operations on the displayed screen. The interface 51 is composed of a contact-type or non-contact-type operation panel. The printer 60 prints information about handling results such as the number and the monetary amount of banknotes deposited or dispensed, on paper as a journal. The card reader 70 reads various cards used in handling by the money handling apparatus 1.

Sensors for detecting banknotes or coins that have been left behind are placed at the outlet 13, the bundle outlet 14, the deposit reject port 23, the loose coin collection box 24, the return box 25, the dispensing box 26, the bag take-up chute 27, the wrapped coin outlet 28a, the wrapped coin collection box 28b, and the external ejection port 28c.

FIG. 3 is a schematic diagram showing an internal configuration of the banknote handling assembly 10.

The banknote handling assembly 10 includes a depositing unit 111, a deposit reject unit 112, a dispensing unit 113, a bundle dispensing unit 114, a transport unit 115, a recognition unit 116, a first inversion unit 117, a second inversion unit 118, a banknote storage unit 119, two stacking units 120, a bundling unit 121, a lifting unit 122, a bundle transport unit 123, and four bundle denomination-specific storage units 124.

The depositing unit 111 is provided in the inlet 12 in FIG. 2. The depositing unit 111 includes a feeding mechanism and feeds out inserted loose notes one by one to the transport unit 115. The deposit reject unit 112 and the dispensing unit 113 are provided in the outlet 13 in FIG. 2. The deposit reject unit 112 mainly receives banknotes that cannot be recognized for their attributes (authenticity, denomination, face/back, etc.) by the recognition unit 116 and cannot be regarded as normal banknotes. The dispensing unit 113 mainly receives banknotes returned from a temporary storage unit 119a or banknotes fed out from a denomination-specific storage unit 119c. The bundle dispensing unit 114 is provided in the bundle outlet 14 and mainly receives bundled banknotes fed out from the bundle denomination-specific storage units 124.

The transport unit 115 is arranged between the depositing unit 111, the deposit reject unit 112, the dispensing unit 113, the temporary storage unit 119a, a collective storage unit 119b, three denomination-specific storage units 119c, and the two stacking units 120, and transports banknotes therebetween.

The recognition unit 116 recognizes the attributes of banknotes flowing through the transport unit 115 and outputs the recognition results to an equipment controller described later. The attributes to be recognized include the authenticity and denomination of each banknote and the face/back and top-bottom direction of each banknote.

The first inversion unit 117 includes an inversion section 117a and a non-inversion section 117b each of which forms a part of the transport unit 115, and causes the faces and the backs of the banknotes flowing through the transport unit 115 to be uniform. The banknotes that have passed through the first inversion unit 117 are each inverted along the short-side direction of the banknote, and the face and the back, and the top and the bottom thereof are interchanged. The second inversion unit 118 includes an inversion transport path 118a that is formed in a spiral shape. The banknotes that have passed through the inversion transport path 118a are each inverted along the long-side direction of the banknote, and the face and the back, and the left and the right thereof are interchanged.

The face and the back and the top and the bottom of each banknote are made uniform by switching between inversion and non-inversion in the first inversion unit 117 and inversion and non-inversion in the second inversion unit 118 for each banknote, based on the recognition results of the face/back and top/bottom of the banknote by the recognition unit 116.

The banknote storage unit 119 includes the temporary storage unit 119a, the collective storage unit 119b, and the three denomination-specific storage units 119c.

The temporary storage unit 119a temporarily stores therein normal banknotes that have been inserted into the depositing unit 111 and recognized for attributes by the recognition unit 116. Banknotes whose faces/backs and tops/bottoms have been made uniform by the first inversion unit 117 and the second inversion unit 118 are transported to and stored in the temporary storage unit 119a. The temporary storage unit 119a includes a feeding mechanism and can feed out the stored banknotes to the transport unit 115.

The collective storage unit 119b stores therein banknotes that have been fed out from the temporary storage unit 119a and whose denominations could not be recognized by the recognition unit 116, banknotes to which no denomination-specific storage unit 119c is assigned, such as 2000-yen notes, overflowing banknotes that could not be stored in the corresponding denomination-specific storage units 119c, etc.

In each denomination-specific storage unit 119c, banknotes that have been fed out from the temporary storage unit 119a and whose denominations have been recognized by the recognition unit 116 are sorted by denomination and stored. For example, denominations of 10000 yen, 1000 yen, and 5000 yen are assigned to the three denomination-specific storage units 119c, respectively. Each denomination-specific storage unit 119c includes a feeding mechanism and can feed out the stored banknotes to the transport unit 115.

The stacking unit 120 stacks therein banknotes that are transported by the transport unit 115 and whose number is equal to a unit number of banknotes to be bundled with a strip (e.g., 100). The bundling unit 121 includes an arm mechanism, a bundling mechanism, and a transport mechanism. The bundling unit 121 takes out a bundle of banknotes stacked in the stacking unit 120, using the arm mechanism, puts a strip around the taken-out bundle of banknotes, using the bundling mechanism, to produce bundled banknotes, and sends the produced bundled banknotes to the lifting unit 122, using the transport mechanism.

The lifting unit 122 has a transport path formed therein in the up-down direction and includes a lift mechanism in the transport path. The lifting unit 122 sends the bundled banknotes sent from the bundling unit 121, to the bundle transport unit 123, which is placed above the lifting unit 122, using the lift mechanism. The bundle transport unit 123 transports the bundled banknotes sent from the lifting unit 122, to the bundle denomination-specific storage unit 124 corresponding to the denomination of the bundled banknotes among the four bundle denomination-specific storage units 124. In addition, the bundle transport unit 123 transports bundled banknotes fed out from each bundle denomination-specific storage unit 124, to the bundle dispensing unit 114.

The four bundle denomination-specific storage units 124 each store therein bundled banknotes of the denomination assigned thereto. For example, a denomination of 10000 yen is assigned to two of the bundle denomination-specific storage units 124, and denominations of 1000 yen and 5000 yen are assigned to the remaining two bundle denomination-specific storage units 124, respectively. Each bundle denomination-specific storage unit 124 includes a feeding mechanism and can feed out the stored bundled banknotes to the bundle transport unit 123.

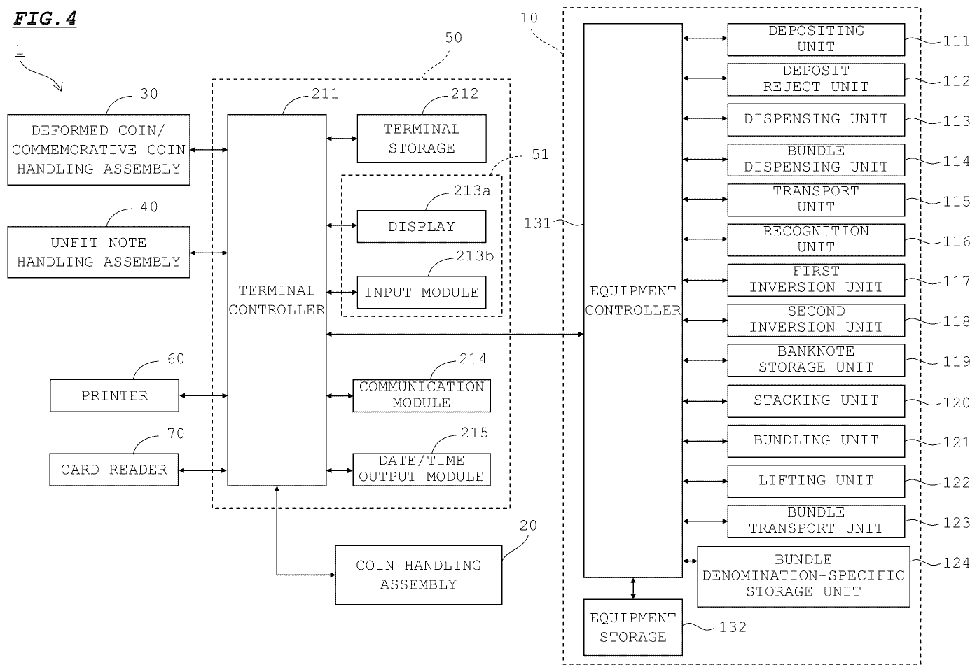

FIG. 4 is a block diagram showing a main configuration of the money handling apparatus 1 according to the present embodiment.

In addition to the components 111 to 124 described above, the banknote handling assembly 10 includes an equipment controller 131 and an equipment storage 132.

The equipment controller 131 includes an arithmetic circuit such as a CPU (central processing unit) and controls the components 111 to 124 according to a program stored in the equipment storage 132. The equipment storage 132 includes storage media such as a ROM (read only memory), a RAM (random access memory), and a hard disk, stores an operation program for the equipment controller 131, and is also used as a work area during control processing of the equipment controller 131.

In addition to the interface 51 described above, the operation terminal 50 includes a terminal controller 211, a terminal storage 212, a communication module 214, and a date/time output module 215.

The interface 51 includes a display 213a and an input module 213b. For example, the display 213a is composed of a liquid crystal panel, and the input module 213b is composed of a transparent touch sensor. In this case, the interface 51 is composed of a touch panel in which an operation panel is superimposed on the liquid crystal panel. The display 213a and the input module 213b may be arranged separately. The display 213a displays various input screens such as a standby screen and a deposit acceptance screen. The input module 213b detects an input of a user to the screen displayed on the display 213a.

The terminal controller 211 includes an arithmetic circuit such as a CPU and controls the interface 51, the printer 60, the card reader 70, etc., according to a program stored in the terminal storage 212. In addition, the terminal controller 211 exchanges various kinds of information (including commands) with the equipment controller 131 of the banknote handling assembly 10 and controllers (not shown) of the coin handling assembly 20, the deformed coin/commemorative coin handling assembly 30, and the unfit note handling assembly 40.

The terminal storage 212 includes storage media such as a ROM, a RAM, and a hard disk, stores an operation program for the terminal controller 211, and is also used as a work area during control processing of the terminal controller 211.

The communication module 214 performs communication with another device such as the camera 2 in FIG. 1 and terminals carried by staff members and superiors. This communication is performed wirelessly. Alternatively, this communication may be performed via a wire. The date/time output module 215 includes a clock circuit, determines the current date and time (day of the week, time) as needed, and outputs the current date and time to the terminal controller 211.

Meanwhile, in the present embodiment, as described with reference to FIG. 1, the money handling apparatus 1 is placed in the room R11 connected to the lobby area A11, and not only staff members but also customers are allowed to perform depositing and dispensing with respect to the money handling apparatus 1. Accordingly, the workload on the staff members can be reduced, and the number of staff members in the establishment S1 can be reduced.

However, in the case where the money handling apparatus 1 is also used for handling by customers, it is expected that customers will have difficulty in smoothly performing handling such as depositing and dispensing, due to being unfamiliar with operating the money handling apparatus 1. In addition, since the money brought in by customers from outside is deposited directly into the money handling apparatus 1, it can be expected that there will be a possibility that problems that are conventionally less likely to occur when a staff member deposits money will often occur.

In view of such problems, in the present embodiment, in the case where not only staff members but also customers perform money handling as described above, control for smoothly and appropriately dealing with money handling from either user is executed. Hereinafter, this control will be described.

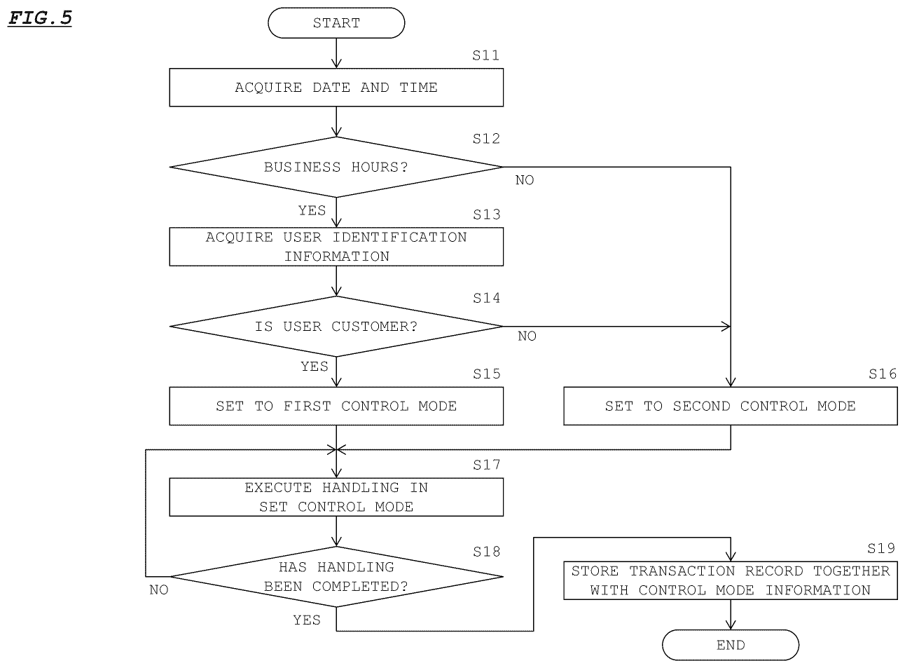

FIG. 5 is a flowchart showing a setting process for a control mode.

The flowchart in FIG. 5 is started, for example, in response to a touch operation from a user on the interface 51 in a sleep state. Alternatively, the flowchart in FIG. 5 may be started in response to detecting that a new user has entered the room R11 in FIG. 1, using an image taken by the camera 2 or an opening/closing sensor for the door D11.

When the flowchart in FIG. 5 starts, the terminal controller 211 acquires the current date and time (day of the week, time) from the date/time output module 215 (S11) and determines whether or not the current date and time is included in the business hours (days of the week, time period) of the establishment S1 (S12). The business hours of the establishment S1 are set in advance by an administrator of the money handling apparatus 1 operating the interface 51.

If the current date and time is not included in the business hours (S12: NO), the user is normally a staff member of the establishment S1, not a customer. Therefore, in this case, the terminal controller 211 determines that the user is a staff member, and sets the control mode of the money handling apparatus 1 to a second control mode that is suitable for staff members (S16).

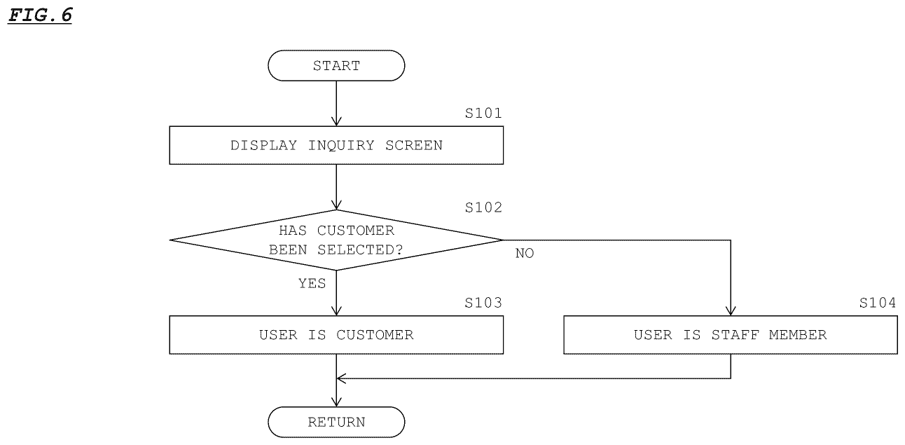

On the other hand, if the current date and time is included in the business hours (S12: YES), the terminal controller 211 acquires user identification information for identifying the user (S13) and determines whether the user is a customer or a staff member, based on the acquired user identification information (S14). The method of acquiring the user identification information and the method of the determination in step S14 will be described later with reference to FIG. 6 to FIG. 9.

If the result of the determination in step S14 is YES, that is, if the user is a customer, the terminal controller 211 sets the control mode of the money handling apparatus 1 to a first control mode that is suitable for customers. On the other hand, if the result of the determination in step S14 is NO, that is, if the user is a staff member, the terminal controller 211 sets the control mode of the money handling apparatus 1 to the second control mode that is suitable for staff members. The set control mode is notified to the controllers of other handling assemblies such as the equipment controller 131 of the banknote handling assembly 10 and the controller of the coin handling assembly 20.

The terminal controller 211 executes money handling for the user by the control mode set as described above (S17). Then, after the money handling is completed (S18: YES), the terminal controller 211 stores the identification information of the control mode set in step S15 or S16, in the terminal storage 212 in association with a transaction record (electronic journal) by this money handling (S19). Accordingly, the terminal controller 211 ends the process in FIG. 5.

Since the identification information of the control mode is associated with the transaction record (electronic journal) in step S19, when the administrator or the like traces and analyzes the transaction record later, it is possible to confirm by which control mode each transaction was performed, that is, by which of a customer or a staff member each transaction was performed. Accordingly, the administrator or the like can more appropriately evaluate the legitimacy, etc., of each transaction.

FIG. 6 is a flowchart showing an example of the process in steps S13 and S14 in FIG. 5.

In this process, the terminal controller 211 displays an inquiry screen for asking the user whether the user is a customer or a staff member, on the interface 51 (S101).

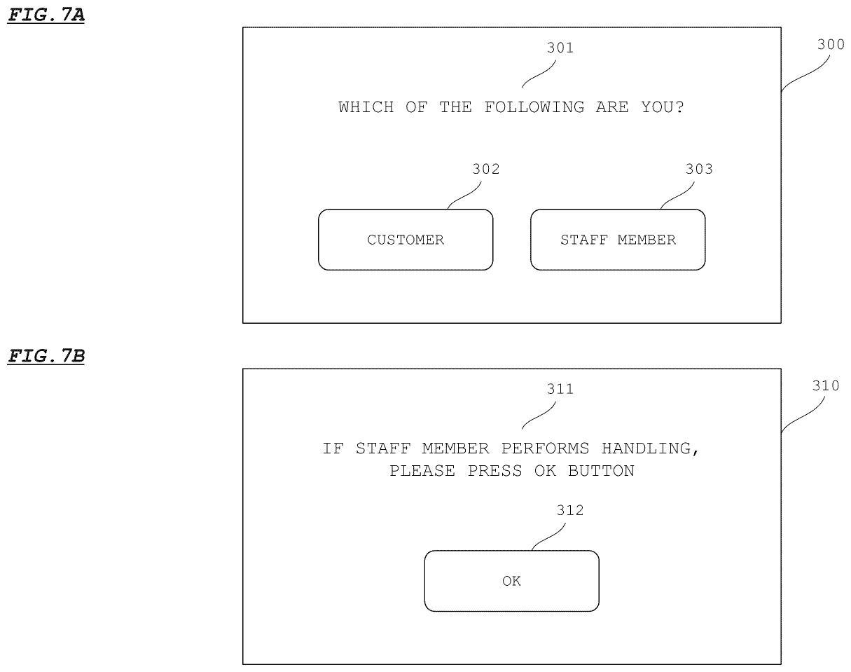

FIG. 7A is a diagram showing an example of an inquiry screen 300.

The inquiry screen 300 includes a message 301 that asks the user whether the user is a customer or a staff member, a selection button 302 for selecting customer, and a selection button 303 for selecting staff member. After referring to the message 301, the user operates the selection button corresponding to the user out of the selection buttons 302 and 303.

Referring back to FIG. 6, it is determined whether any of the two selection buttons 302 and 303 included in the inquiry screen 300 has been operated (S102). If the selection button 302 in FIG. 7A has been operated, the terminal controller 211 determines YES in step S102 and determines that the user is a customer (S103). If the selection button 303 in FIG. 7A has been operated, the terminal controller 211 determines NO in step S102 and determines that the user is a staff member (S104).

In step S101, an inquiry screen 310 in FIG. 7B may be displayed. The inquiry screen 310 includes an OK button 312 and a message 311 that urges the user to operate the OK button 312 if the user is a staff member.

In this case, in step S102 in FIG. 6, it is determined whether or not the OK button 312 has been operated within a predetermined time (e.g., about 10 seconds). If the OK button 312 has not been operated within the predetermined time (the time has elapsed), the terminal controller 211 determines YES in step S102 and determines that the user is a customer (S103). On the other hand, if the OK button 312 has been operated within the predetermined time, the terminal controller 211 determines NO in step S102 and determines that the user is a staff member (S104).

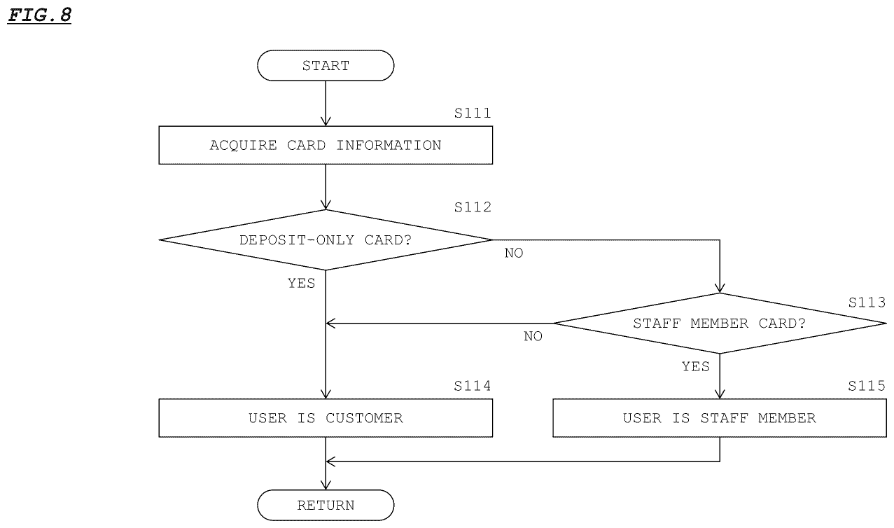

FIG. 8 is a flowchart showing another example of the process in steps S13 and S14 in FIG. 5.

This process is a process that can be performed when a card carried by a customer or staff member is read by the card reader 70 prior to money handling. For example, a deposit-only card is issued by the establishment S1 to a customer in order to deposit money into the money handling apparatus 1. In this card, information including the identification information of the customer to whom this card is issued and identification information indicating that this card is a deposit-only card, is stored. In addition, a staff member card is provided by the establishment S1 to a staff member. In this card, information including the identification information of the staff member carrying this card and identification information indicating that this card is a staff member card, is stored.

Here, when the staff member performs handling with respect to the money handling apparatus 1, an operation for reading the staff member card by the card reader 70 is mandatory. On the other hand, when the customer performs a depositing process with respect to the money handling apparatus 1, an operation for reading the deposit-only card by the card reader 70 is optional.

In the process in FIG. 8, first, the terminal controller 211 acquires card information from the card carried by the user (S111). In step S111, the terminal controller 211 may display a guidance message for causing the card reader 70 to read the deposit-only card or the staff member card carried by the user, on the interface 51. Alternatively, the terminal controller 211 may output this guidance message as audio from a speaker (not shown) of the operation terminal 50. These guidance messages may include the fact that the operation for reading the staff member card is mandatory and that the operation for reading the deposit-only card is optional.

In response to these messages, the user causes the card reader 70 to read the own card. The card reader 70 outputs the card information read from the card, to the terminal controller 211. The terminal controller 211 determines whether the card is a deposit-only card or a staff member card, from the card information acquired from the card reader 70 (S112, S113).

If the card is a deposit-only card (S112: YES), the terminal controller 211 determines that the user is a customer (S114). On the other hand, if the card is a staff member card (S112: NO, S113: YES), the terminal controller 211 determines that the user is a staff member (S115).

If the terminal controller 211 fails to acquire the card information from the card reader 70 within a predetermined time, the terminal controller 211 determines NO in both of steps S112 and S113 and determines that the user is a customer (S114). That is, since the operation for reading the deposit-only card is optional as described above, if, for example, the customer has inadvertently forgotten to bring their deposit-only card, the customer does not perform the operation for reading on the card reader 70. On the other hand, since the operation for reading the staff member card is mandatory, if the user is a staff member, the operation for reading the staff member card is always performed. Therefore, if the terminal controller 211 fails to acquire the card information from the card reader 70 within the predetermined time, the terminal controller 211 determines NO in both of steps S112 and S113 and determines that the user is a customer (S114).

In the case where the establishment S1 does not issue deposit-only cards to customers, step S112 is omitted from the process in FIG. 8, and the process proceeds from step S111 to step S113. In this case, if the terminal controller 211 has successfully acquired the card information of the staff member card within the predetermined time (S113: YES), the terminal controller 211 determines that the user is a staff member (S115), and if the terminal controller 211 has failed to acquire the card information of the staff member card within the predetermined time (S113: NO), the terminal controller 211 determines that the user is a customer (S114).

The storage medium used to determine the type of the user may be a storage medium of another form such as a mobile terminal that incorporates an IC chip, in addition to a card. In this case, a reader device corresponding to this storage medium is included in the money handling apparatus 1. In this case as well, the storage medium holds information for identifying whether the person carrying the storage medium is a customer or a staff member, and the terminal controller 211 determines whether the user is a customer or a staff member, based on this information.

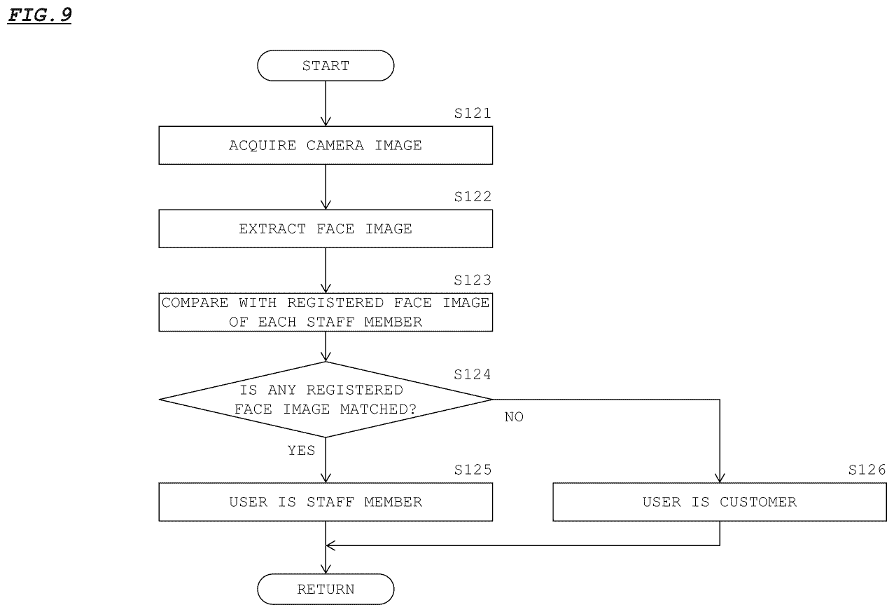

FIG. 9 is a flowchart showing still another example of the process in steps S13 and S14 in FIG. 5.

In this process, whether the user is a customer or a staff member is determined from an image acquired by the camera 2 in FIG. 1.

The terminal controller 211 acquires an image that overlooks the front of the money handling apparatus 1, from the camera 2 (S121). The terminal controller 211 extracts a face image of the user from the acquired image (S122) and compares the extracted face image with a registered face image of each staff member (S123). Face images of all staff members who belong to the establishment S1 are stored in the terminal storage 212 in advance. The registered face image does not have to be an image itself but may be a face feature amount. In this case, a feature amount is further extracted from the face image of the user acquired from the camera 2 this time, and the extracted feature amount and the feature amount of the registered face image of each staff member are compared with each other.

If the face image of the user this time matches any of the registered face images, that is, if the degree of matching between these two images is equal to or higher than a predetermined threshold value (S124: YES), the terminal controller 211 determines that the user is a staff member (S125). On the other hand, if the face image of the user this time does not match any of the registered face images (S124: NO), the terminal controller 211 determines that the user is a customer (S126).

In the process in FIG. 9, the user is not required to perform a predetermined input or an operation for reading a card as in FIG. 6 or FIG. 8, and thus it can be determined more simply whether the user is a customer or a staff member.

The image used to determine the type of the user may be an image of the user other than a face image. For example, a clothing image of the user may be extracted from the image taken by the camera 2. If the shape and color of the extracted clothing image match the shape and color of an image of a staff member's uniform that has been registered in advance, it may be determined that the user is a staff member, and in other cases, it may be determined that the user is a customer. Alternatively, if a rule that a staff member performs a predetermined hand sign when using the money handling apparatus 1 is set in the money handling apparatus 1, a hand sign of the user may be extracted from the image taken by the camera 2. If the extracted hand sign matches a hand sign that has been registered in advance, it may be determined that the user is a staff member, and in other cases, it may be determined that the user is a customer.

### <Switching of Display Form>

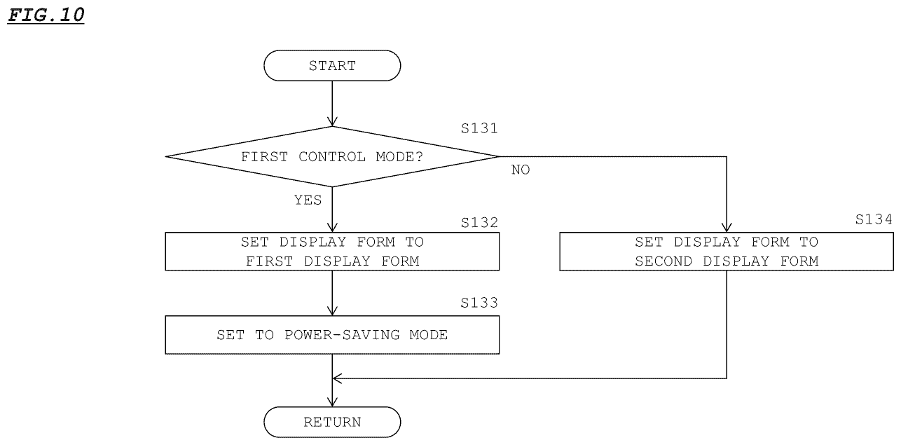

FIG. 10 is a flowchart showing an example of the process in step S17 in FIG. 5.

In this process, the display form of the display 213a is made different between the first control mode and the second control mode. That is, if the first control mode is set by the process in steps S14 to S16 in FIG. 5 (S131: YES), the terminal controller 211 sets the display form of the display 213a to a first display form (S132) and further sets display control for the display 213a to a power-saving mode (S133). In addition, if the second control mode is set by the process in steps S14 to S16 in FIG. 5 (S131: NO), the terminal controller 211 sets the display form of the display 213a to a second display form (S134).

Here, the power-saving mode is a control mode in which, if there is no operation on the screen for a predetermined time or longer, the display 213a is set to a sleep state (backlight off state), and the sleep state is cancelled when an operation is performed on the screen later. In the second control mode, the power-saving mode is not executed, and the display 213a is set to an always-on state.

If the user is a customer, it is expected that the interval between a series of processes for money handling will be long. Therefore, if the display 213a is always in operation, unnecessary power consumption occurs, and the lifespan of the components included in the display 213a is also shortened. On the other hand, if the user is a staff member, the interval between the series of processes is short. Therefore, the staff member can more efficiently carry out this series of processes if the display 213a is in an always-on state.

For this reason, in the process in FIG. 10, in the first control mode for the case where the user is a customer, the power-saving mode is set for the display 213a (S133), and in the second control mode for the case where the user is a staff member, the power-saving mode is not set for the display 213a. Accordingly, it is possible to save power during customer use and achieve a longer lifespan, while keeping the work efficiency of the staff member high.

### <Switching of Menu Screen>

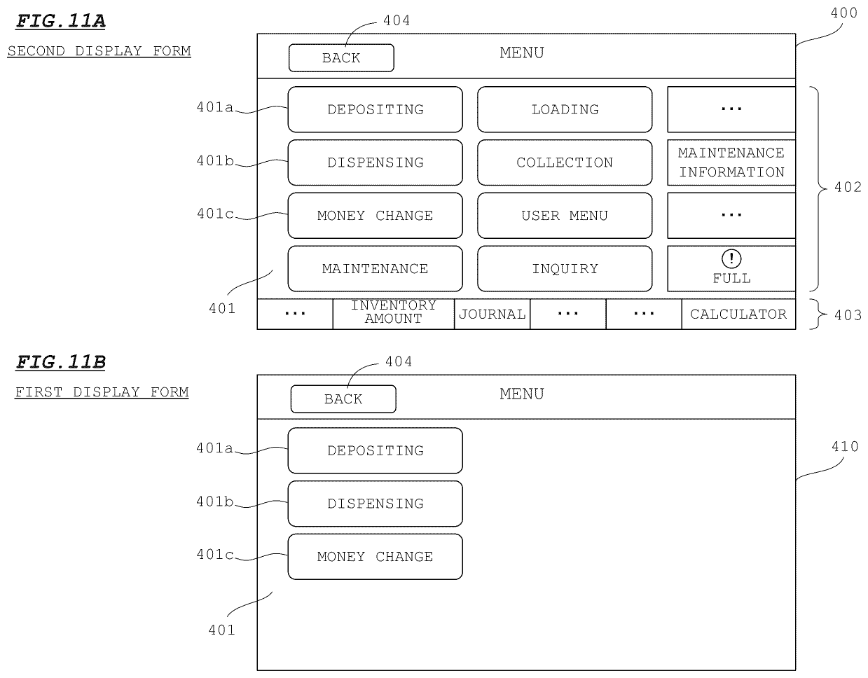

FIG. 11A is a diagram showing a configuration example of a menu screen 400 when the display form is set to the second display form by step S134 in FIG. 10. FIG. 11B is a diagram showing a configuration example of a menu screen 410 when the display form is set to the first display form by step S132 in FIG. 10.

As shown in FIG. 11A, the menu screen 400 in the second display form includes a selection button group 401, an icon group 402, a footer portion 403, and a back button 404. The back button 404 is a button for returning to the previous screen.

The selection button group 401 is composed of a plurality of selection buttons for selecting a process with respect to the money handling apparatus 1. Here, the selection button group 401 includes a selection button 401a for performing a depositing process, a selection button 401b for performing a dispensing process, and a selection button 401c for performing money change, and further includes five selection buttons for performing maintenance, loading money, collecting money, other menus, and checking transaction records, respectively.

The icon group 402 includes a plurality of icons for displaying maintenance information, the money storage state in each money storage unit, etc. The footer portion 403 includes items for displaying the inventory amounts in the banknote handling assembly 10 and the coin handling assembly 20, an item for displaying an electronic journal, an item for displaying a calculator, etc.

As shown in FIG. 11B, the menu screen 410 in the first display form includes only the selection button group 401 and the back button 404 of the menu screen 400 in FIG. 11A, and the icon group 402 and the footer portion 403 are omitted. In addition, in the menu screen 410, the selection button group 401 is limited to the three selection buttons 401a, 401b, and 401c for performing depositing, dispensing, and money change, respectively.

As described above, the menu screen 400 in the second display form includes various displays and selection buttons necessary for the staff member. Accordingly, the staff member can smoothly perform the desired process. In addition, the menu screen 410 in the first display form includes only selection buttons necessary for the customer. Accordingly, the customer can smoothly and appropriately select the desired process without being confused by displays or selection items that are not necessary for the customer and without performing an erroneous operation on these displays or selection items.

### <Switching of Deposit Screen>

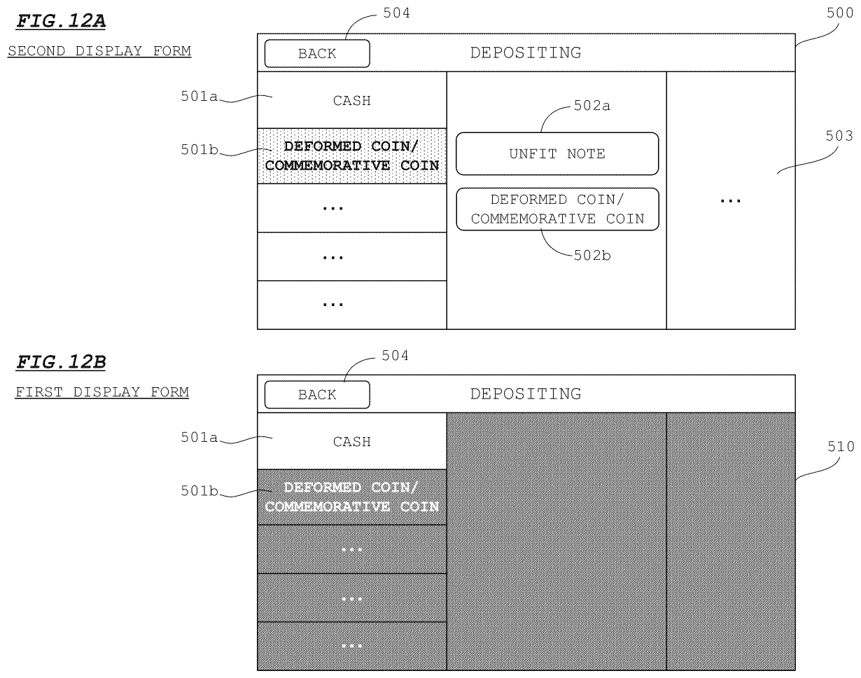

FIG. 12A is a diagram showing a configuration example of a deposit screen 500 displayed when the selection button 401a for depositing is operated on the menu screen 400 in FIG. 11A. FIG. 12B is a diagram showing a configuration example of a deposit screen 510 displayed when the selection button 401a for depositing is operated on the menu screen 410 in FIG. 11B.

As shown in FIG. 12A, the deposit screen 500 in the second display form includes selection items 501a and 501b for selecting the type of money to be deposited and a back button 504 for returning to the previous screen.

The selection item 501a is selected when the money to be deposited is cash (normal money that can be handled by a machine). The selection item 501b is selected when the money to be deposited is an unfit note, a deformed coin, or a commemorative coin. In FIG. 12A, the selection item 501b is selected. When the selection item 501b is selected, selection buttons 502a and 502b for selecting whether the money to be deposited is an unfit note, or a deformed coin or commemorative coin, are further displayed in a central region. In a right-side region 503, an operation method for handling an unfit note, a deformed coin, and a commemorative coin in the deformed coin/commemorative coin handling assembly 30 and the unfit note handling assembly 40 is displayed together with a guide image.

When the selection button 502a is operated, the terminal controller 211 operates the unfit note handling assembly 40 and starts an unfit note process. When the selection button 502b is operated, the terminal controller 211 operates the deformed coin/commemorative coin handling assembly 30 and starts a deformed coin/commemorative coin process. The unfit note process by the unfit note handling assembly 40 and the deformed coin/commemorative coin process by the deformed coin/commemorative coin handling assembly 30 are as described above.

When the selection item 501a is operated on the deposit screen 500, the terminal controller 211 executes a process related to depositing of cash. In this case, the terminal controller 211 executes a process for a depositing operation from the user in cooperation with the equipment controller 131 of the banknote handling assembly 10 and the controller of the coin handling assembly 20 while displaying an acceptance screen for a depositing process on the interface 51.

As shown in FIG. 12B, on the deposit screen 510 in the first display form, only the selection item 501a out of the selection items 501a and 501b for selecting the type of money to be deposited is set to be operable, and the other selection item and the central and right regions are grayed out so as not to be operable. The customer who is the user can operate only the selection item 501a or the back button 504. In depositing cash, the customer operates the selection item 501a. Accordingly, the terminal controller 211 executes a process related to depositing of cash as described above.

As described above, the deposit screen 500 in the second display form includes the selection items 501a and 501b corresponding to a depositing process from the staff member. Accordingly, the staff member can smoothly perform a depositing process corresponding to the type of money to be deposited. In addition, on the deposit screen 510 in the first display form, only the selection item 501a for depositing cash is set to be operable. Accordingly, the customer can smoothly and appropriately deposit cash as intended by the customer, without mistakenly selecting a depositing process for an unfit note and a deformed coin/commemorative coin.

<Switching of Process when Error Occurs>

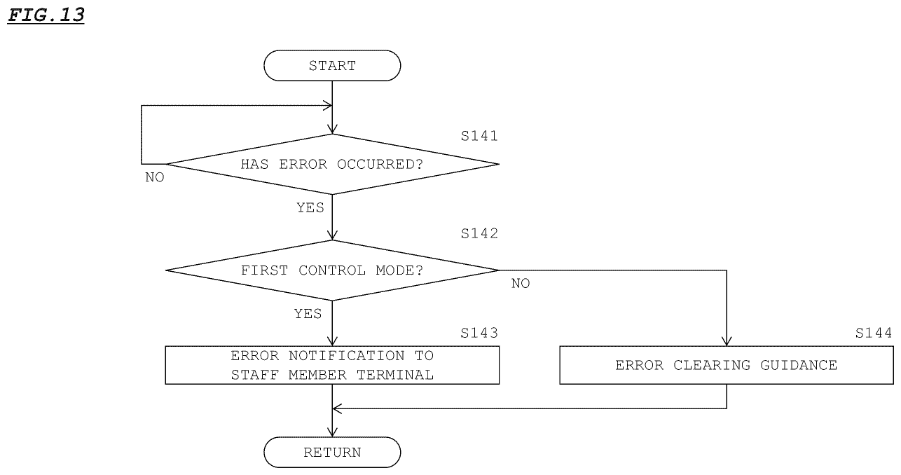

FIG. 13 is a flowchart showing another example of the process in step S17 in FIG. 5.

In this process, a process when an error occurs in the money handling apparatus 1 is made different between the first control mode and the second control mode.

If an error such as a banknote jam occurs in the middle of money handling in the money handling apparatus 1 (S141: YES), the terminal controller 211 determines whether the currently set control mode is the first control mode or the second control mode (S142). If the currently set control mode is the first control mode (S142: YES), the terminal controller 211 notifies the terminal of the staff member or a terminal of a customer center in the establishment S1 of the occurrence of the error via the communication module 214 (S143). Accordingly, the staff member or the like quickly comes to the money handling apparatus 1 and performs an operation for clearing the error.

On the other hand, if the currently set control mode is the second control mode (S142: NO), the terminal controller 211 executes a guidance process for clearing the error (S144). In step S144, the terminal controller 211 causes the money handling assembly (the banknote handling assembly 10 or the like) in which the error has occurred to perform a process for clearing the error. Accordingly, in the money handling assembly, control for unlocking the relevant part, etc., is performed.

The process in FIG. 10 is performed in parallel with the process in FIG. 13. Accordingly, the display form when an error occurs is switched between the first control mode and the second control mode.

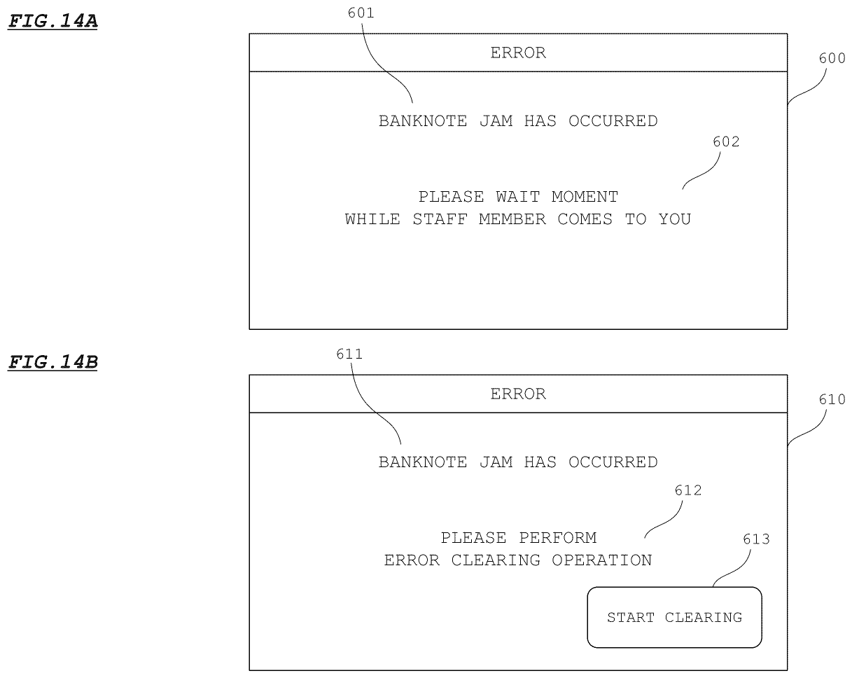

FIG. 14A is a diagram showing a configuration example of an error screen 600 when an error occurs in the first control mode. FIG. 14B is a diagram showing a configuration example of an error screen 610 when an error occurs in the second control mode.

As shown in FIG. 14A, the error screen 600 in the first control mode includes a message 601 that indicates the content of the error and a message 602 that urges the customer to wait until the staff member arrives. Accordingly, the customer who is the user waits for the staff member to arrive.

Meanwhile, as shown in FIG. 14B, the error screen 610 in the second control mode includes a message 611 that indicates the content of the error, a message 612 that urges the staff member, who is the user, to perform an operation for clearing the error, and an operation button 613 for starting the clearing operation. Accordingly, the staff member who is the user operates the operation button 613 and performs the operation for clearing the error. When the operation button 613 is operated, the terminal controller 211 displays a series of guide screens for clearing the error on the interface 51 in order in accordance with the operation status from the staff member. The staff member performs operations for clearing the error in order according to the guide screens.

### <Switching of Control in Depositing Process>

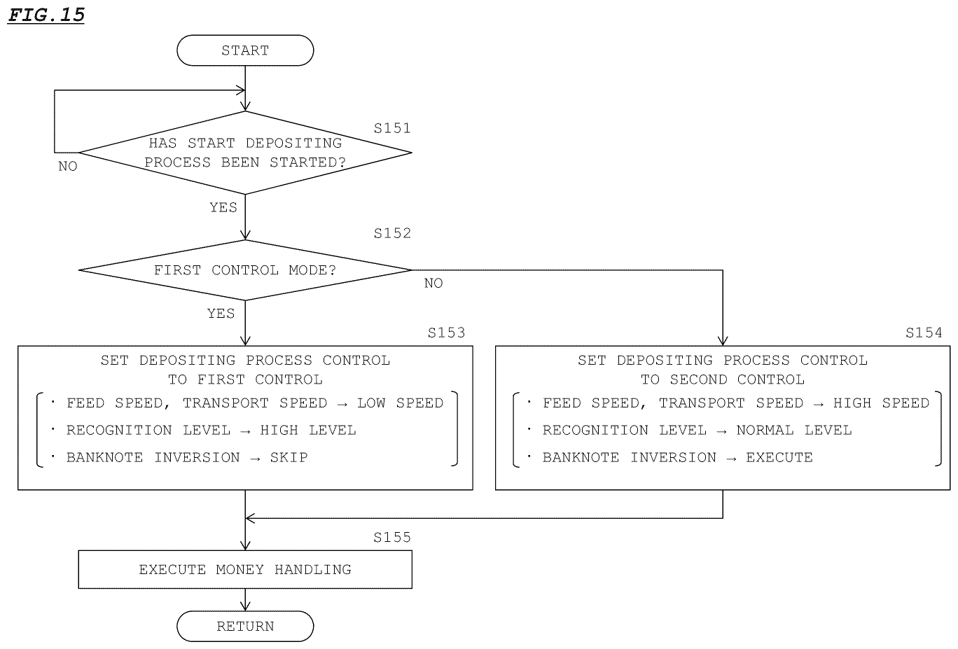

FIG. 15 is a flowchart showing still another example of the process in step S17 in FIG. 5.

In this process, control in a depositing process is made different between the first control mode and the second control mode. Here, the depositing process means a process of depositing cash.

When a depositing process is started (S151: YES), the terminal controller 211 determines whether the current control mode is the first control mode or the second control mode (S152). If the current control mode is the first control mode (S152: YES), the terminal controller 211 sets control for the depositing process to first control (S153). On the other hand, if the current control mode is the second control mode (S152: NO), the terminal controller 211 sets the control for the depositing process to second control (S154).

Here, in the first control, the banknote feed speed and transport speed are made lower than in the second control. That is, in the first control, the banknote feed speed and transport speed are set to low speeds, and in the second control, the banknote feed speed and transport speed are set to high speeds. For example, the banknote feed speed and transport speed in the second control are set to about the maximum speeds in the respective speed ranges thereof, and the banknote feed speed and transport speed in the first control are set to about 70 to 80% of the maximum speeds in the respective speed ranges thereof.

Similarly, the coin feed speed and transport speed may be switched between the first control and the second control. That is, the coin feed speed and transport speed may be set lower in the first control than in the second control. The coin feed speed and transport speed in the second control may be set to the maximum speeds in the respective speed ranges thereof.

In addition, in the first control, the level of recognition of banknotes is made higher than in the second control. For example, a threshold value for certainty for determining that a banknote is a fit note is made higher in the first control than in the second control. Similarly, the level of recognition of coins may be switched between the first control and the second control. That is, the level of recognition of coins may be set higher in the first control than in the second control.

Furthermore, in the first control, the banknote inversion operation in the first inversion unit 117 and the second inversion unit 118 in FIG. 3 is not performed, but in the second control, the banknote inversion operation in these inversion units is performed.

The terminal controller 211 causes the banknote handling assembly 10 and the coin handling assembly 20 to perform money handling according to the first control or second control set as described above (S155).

When the staff member performs a depositing operation, the staff member inserts money confirmed visually by the staff member in a normal state (no damage, properly aligned, no foreign matter, etc.), so that the above-described second control is set in consideration of the work efficiency of the staff member. On the other hand, when the customer performs a depositing operation, there is a possibility that money whose state has not been checked will be inserted, so that the above-described first control is set with priority given to accuracy. Since control for money handling in the first control mode for the case of customer use (first control) and control for money handling in the second control mode for the case of staff member use (second control) are made different from each other as described above, while money handling is efficiently performed during staff member use, the occurrence of an error during customer use can be suppressed, and a counterfeit coin or a deformed coin can be inhibited from being deposited.

<Switching of Control when Money is Left Behind>

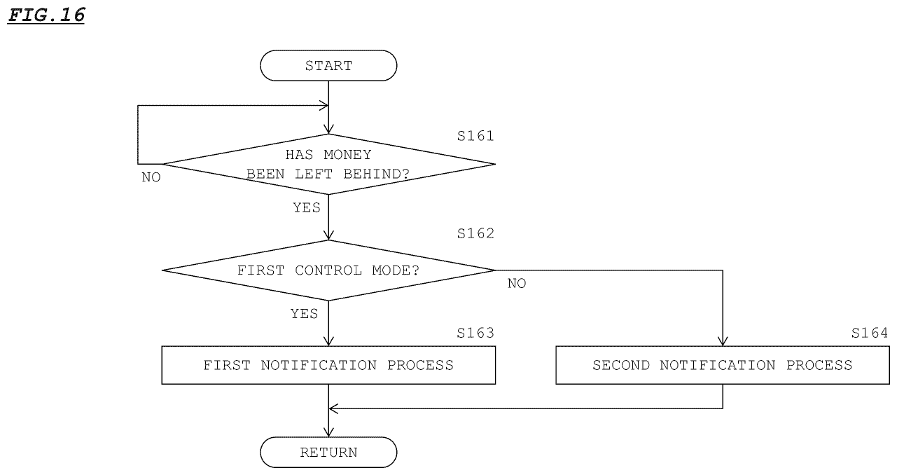

FIG. 16 is a flowchart showing still another example of the process in step S17 in FIG. 5.

In this process, control when deposited money or money returned in a depositing process is left behind is made different between the first control mode and the second control mode. For example, after a dispensing process is completed, the terminal controller 211 determines that money has been left behind, based on detection of money remaining for a predetermined time or longer by the above-described sensor placed in each banknote or coin dispensing unit.

If money has been left behind (S161: YES), the terminal controller 211 determines whether the current control mode is the first control mode or the second control mode (S162). If the current control mode is the first control mode (S162: YES), the terminal controller 211 executes a first notification process (S163). On the other hand, if the current control mode is the second control mode (S162: NO), the terminal controller 211 executes a second notification process (S164).

In the first notification process, the terminal controller 211 outputs a warning sound from the speaker placed in the operation terminal 50, for a fixed time (e.g., a dozen seconds). The warning sound is outputted at a volume that allows the warning sound to be reliably heard not only in the room R11 but also in the lobby area A11 near the room R11. At this time, a message audio that notifies that money has been left behind may also be outputted. In addition, this message may be displayed on the interface 51.

In the second notification process, the terminal controller 211 displays a screen for notifying that money has been left behind, on the interface 51 for a fixed time (e.g., a few seconds). At this time, the terminal controller 211 does not output a warning sound as in the first notification process. Alternatively, the terminal controller 211 may output a weak notification sound (a chime or the like) that can only be heard in the vicinity of the money handling apparatus 1, for a short time (about 1 second).

As described above, the terminal controller 211 sets the notification output in the first notification process for the case of customer use to be stronger than the notification output in the second notification process for the case of staff member use. Accordingly, during customer use, it can be reliably notified to the customer that money has been left behind, and during staff member use, it can be notified to the staff member that money has been left behind, without causing any trouble for the customer staying the lobby area A11.

<Cooperation with Counting System>

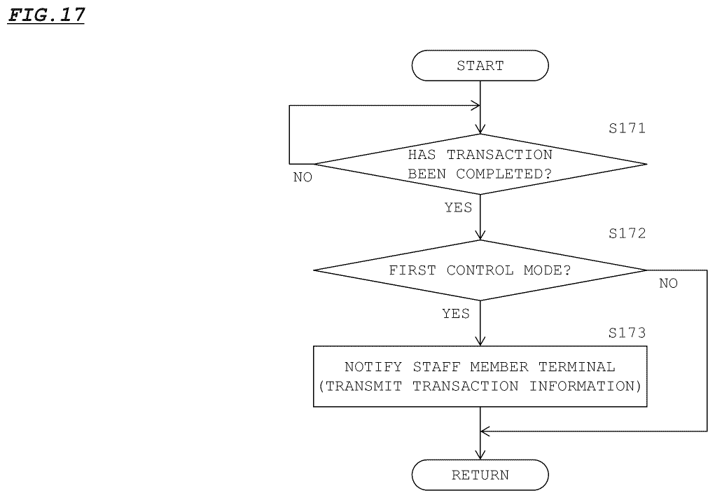

FIG. 17 is a flowchart showing still another example of the process in step S17 in FIG. 5.

In this process, a process related to cooperation with a counting system is made different between the first control mode and the second control mode.

When the customer performs depositing or dispensing with respect to the money handling apparatus 1, a process of reflecting the amount of deposited or dispensed money in a counting system that manages a deposit account ledger is further performed. In this case, the amount of deposited or dispensed money is reflected in the counting system by the staff member after the staff member confirms that a transaction has been completed with this amount of deposited or dispensed money. In the flowchart in FIG. 17, a process for smoothly performing this confirmation and reflection by the staff member is performed.

When a transaction process with respect to the money handling apparatus 1 is completed (S171: YES), the terminal controller 211 determines whether the current control mode is the first control mode or the second control mode (S172). If the current control mode is the first control mode (S172: YES), the terminal controller 211 transmits a transaction completion notification to the terminal of the staff member (S173). Transaction information including the monetary amount of transaction this time, customer information, and information of a destination to which the money was deposited, is added to the transaction completion notification. On the other hand, if the current control mode is the second control mode (S172: NO), the terminal controller 211 skips step S173 and ends the process.

As described above, in the first control mode during use by the customer, the terminal controller 211 transmits the transaction completion notification together with the transaction information to the terminal of the staff member. Accordingly, the customer does not have to move to the staff member's counter C11 after the transaction, and the staff member can smoothly carry out confirmation of the customer's transaction amount and transaction completion and the process of reflecting the transaction amount in the counting system, via the terminal of the staff member.

### <Switching of Control During Large Deposit>

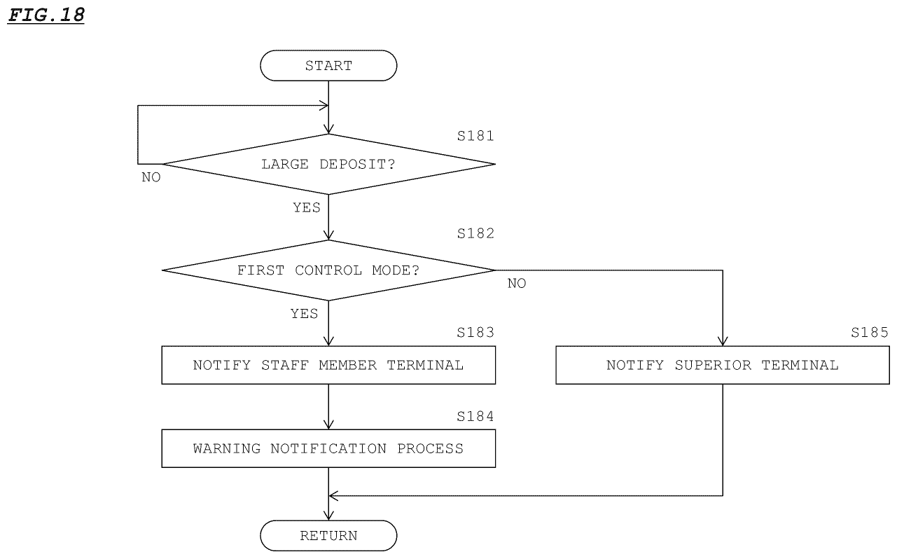

FIG. 18 is a flowchart showing still another example of the process in step S17 in FIG. 5.

In this process, a process during a large deposit is made different between the first control mode and the second control mode. A large deposit means, for example, a deposit of a large amount of money equal to or larger than 1,000,000 yen. Whether or not the deposit is a large deposit is determined, for example, based on a monetary amount entered on an input screen for the amount of money to be deposited, which is displayed before feeding-out of money is started. Alternatively, whether or not the deposit is a large deposit may be determined based on a counting result (total monetary amount) obtained by counting all fed-out money via the recognition unit 116.

When a large deposit is made (S181: YES), the terminal controller 211 determines whether the current control mode is the first control mode or the second control mode (S182). If the current control mode is the first control mode (S182: YES), the terminal controller 211 notifies the terminal of the staff member that the large deposit has been made (S183). Furthermore, the terminal controller 211 executes a warning notification process for warning the customer about whether or not there is a problem with making the large deposit to a deposit destination specified by the customer when a depositing operation was performed (S184). In step S184, the terminal controller 211 displays a screen for warning, on the interface 51. At this time, the terminal controller 211 may further output a message audio for warning, from the speaker.

On the other hand, if the current control mode is the second control mode (S182: NO), the terminal controller 211 notifies the terminal of the superior for the staff member that the large deposit has been made (S185).

As described above, the terminal controller 211 notifies the terminal of the staff member of a large deposit in the first control mode for the case of customer use, and notifies the terminal of the superior of a large deposit in the second control mode for the case of staff member use. Accordingly, during customer use, the staff member can monitor and assist an operation related to a large deposit and performed by the customer, and during staff member use, the superior can monitor an operation related to a large deposit and performed by the staff member. In addition, the terminal controller 211 provides a warning to the customer in the first control mode for the case of customer use. Accordingly, the customer can be prevented from making a dishonestly guided deposit or making a deposit to a wrong deposit destination.

### Effects of Embodiment

According to the present embodiment, the following effects can be achieved.

As shown in FIG. 5 and FIG. 6 to FIG. 9, the terminal controller 211 (controller) selectively executes the first control mode for the case where the user is a customer (S15) and the second control mode for the case where the user is a staff member (S16), based on the information from the date/time output module 215, the interface 51, the card reader 70, or the camera 2 (information output device) (S14). Accordingly, when the user is the customer, the first control mode, which is suitable for customers, is executed, and when the user is the staff member, the second control mode, which is suitable for staff members, is executed. Therefore, it is possible to smoothly and appropriately deal with money handling from either user.

As shown in FIG. 2, the money handling apparatus 1 includes the interface 51 that accepts operations from the user and the card reader 70 (interface). As shown in FIG. 6, FIG. 7A, FIG. 7B, and FIG. 8, the terminal controller 211 (interface) determines whether the user is a customer or a staff member, based on the information from the interface 51 and the card reader 70, and selectively executes the first control mode and the second control mode, based on the result of the determination. With this configuration, whether the user is a customer or a staff member can be determined based on an operation of the user on the interface.

Here, with the process in FIG. 6, whether the user is a customer or a staff member can be determined by the input module 213b accepting the selection of whether the user is a customer or a staff member on the inquiry screen 300 or 310 shown in FIG. 7A or 7B.

With the process in FIG. 7A and FIG. 8, whether the user is a customer or a staff member can be determined by comparing the information read from the card of the user by the card reader 70 with management information that associates the staff member with the card information of the staff member card, or management information that associates the customer with the card information of the deposit-only card.

As shown in FIG. 5, the terminal controller 211 (controller) selectively executes the first control mode and the second control mode, based on whether or not the information about the date and time outputted from the date/time output module 215 (information output device) is included in the preset business hours (S12). Accordingly, if the date and time when the user is to perform an operation for money handling on the money handling apparatus 1 is not included in the business hours (S12: NO), it is determined that the user is a staff member, and the second control mode is selected (S16). Therefore, the second control mode can be appropriately executed based on the date and time of the operation on the money handling apparatus 1.

As shown in FIG. 9, the terminal controller 211 (controller) determines whether the user is a customer or a staff member, based on the face image of the user outputted from the camera 2 (S124 and S125), and selectively executes the first control mode and the second control mode, based on the result of the determination. With this configuration, by registering in advance the face image of each staff member belonging to the establishment as described above, whether the user is a customer or a staff member can be determined by comparing the face image outputted from the camera 2 with the registered face image.

As shown in FIG. 15, the terminal controller 211 (controller) makes the control for money handling differ between the first control mode and the second control mode (S153, S154). Accordingly, control for money handling can be divided based on whether the customer is a staff member, and control suitable for each case can be executed.

In this case, the terminal controller 211 (controller) makes the money transport speed in the first control mode (S153) lower than in the second control mode (S154).

When the customer performs a depositing operation on the banknote handling assembly 10, for example, banknotes with a poor condition may be inserted, or the alignment of banknotes to be inserted may be insufficient compared to that by the staff member. In such a case, if banknotes are fed out and transported at the same high feed speed and transport speed as when the staff member performs a depositing operation, a banknote jam is likely to occur in the transport path. In contrast, with the above control, by steps S153 and S154, the money feed speed and transport speed in the first control mode for the case of customer use are made lower than in the second control mode for the case of staff member use. Accordingly, during customer use, the occurrence of an error such as a money jam due to money transport can be suppressed.

In addition, the terminal controller 211 (controller) makes the level of recognition of money in the first control mode (S153) higher than in the second control mode (S154).

Unlike the staff member, it is expected that the customer usually inserts money without prior confirmation. For this reason, when the customer performs a depositing operation, the customer may accidentally insert a counterfeit note, an unfit note, or the like. In contrast, with the above control, by steps S153 and S154, the level of recognition of money in the first control mode for the case of customer use is made higher than in the second control mode for the case of staff member use. Accordingly, a counterfeit note, an unfit note, or the like can be inhibited from being accidentally deposited into the money handling apparatus 1 during customer use.

As shown in FIG. 10, the terminal controller 211 (controller) makes the display form of the display differ between the first control mode and the second control mode (S132, S134). Accordingly, the display on the interface 51 (display 213a) is made suitable for customers in the first control mode for the case of customer use and is made suitable for staff members in the second control mode for the case of staff member use. Accordingly, the customer and the staff member can smoothly advance money handling according to the display on the interface 51 (display 213a).

In this case, the terminal controller 211 (controller) limits the types of operation items displayed on the acceptance screen displayed on the interface 51 (display 213a) in the first control mode (first display form) as shown in FIG. 11A to FIG. 12B, compared to the second control mode (second display form). Accordingly, in the first control mode for the case of customer use, the operation items that are unnecessary for customers are omitted. Therefore, the customer can smoothly perform the operations that have to be performed by the customer, without getting confused or performing an erroneous operation.

As shown in FIG. 2, the money handling apparatus 1 includes a plurality of money handling assemblies (the banknote handling assembly 10, the coin handling assembly 20, the deformed coin/commemorative coin handling assembly 30, the unfit note handling assembly 40) that perform different processes. As shown in FIGS. 12A and 12B, the terminal controller 211 (controller) limits the money handling assemblies that can be used by the user in the first control mode, compared to the second control mode. Accordingly, the money handling assemblies (the deformed coin/commemorative coin handling assembly 30, the unfit note handling assembly 40) that have to be restricted from being accessed from customers are excluded from the money handling assemblies to be used by customers. Therefore, erroneous deposits and unauthorized access to these money handling assemblies can be prevented in advance.

As shown in FIG. 13, FIG. 17, and FIG. 18, the terminal controller 211 (controller) switches the mode of communication with another device (the terminal of the staff member or the superior) between the first control mode and the second control mode (S143, S163, S164, S173). With this configuration, the mode of communication with the other device can be switched between a communication mode suitable for customer use and a communication mode suitable for staff member use. Accordingly, it is possible to smoothly advance handling via the other device during customer use and during staff member use.

In this case, as shown in FIG. 13, when an error occurs during money handling in the first control mode (S141: YES, S142: YES), the terminal controller 211 (controller) transmits a notification indicating the occurrence of the error to the terminal of the staff member (other device) (S143) without performing control for clearing the error (S144), and when an error occurs during money handling in the second control mode (S141: YES, S142: NO), the terminal controller 211 (controller) performs control for clearing the error (S144) without transmitting a notification indicating the occurrence of the error (S143) to the terminal of the staff member (other device). Accordingly, when an error occurs during customer use, the staff member can smoothly deal with the error in response to the notification to the terminal of the staff member, and during staff member use, the staff member can smoothly deal with the error while avoiding sending an unnecessary notification to another device.

### Modification 1

In Modification 1, the configurations of the depositing unit 111 and the dispensing unit 113 of the banknote handling assembly 10 shown in FIG. 2 are changed. In Modification 1, depositing and dispensing of banknotes are performed with respect to one depositing/dispensing unit.

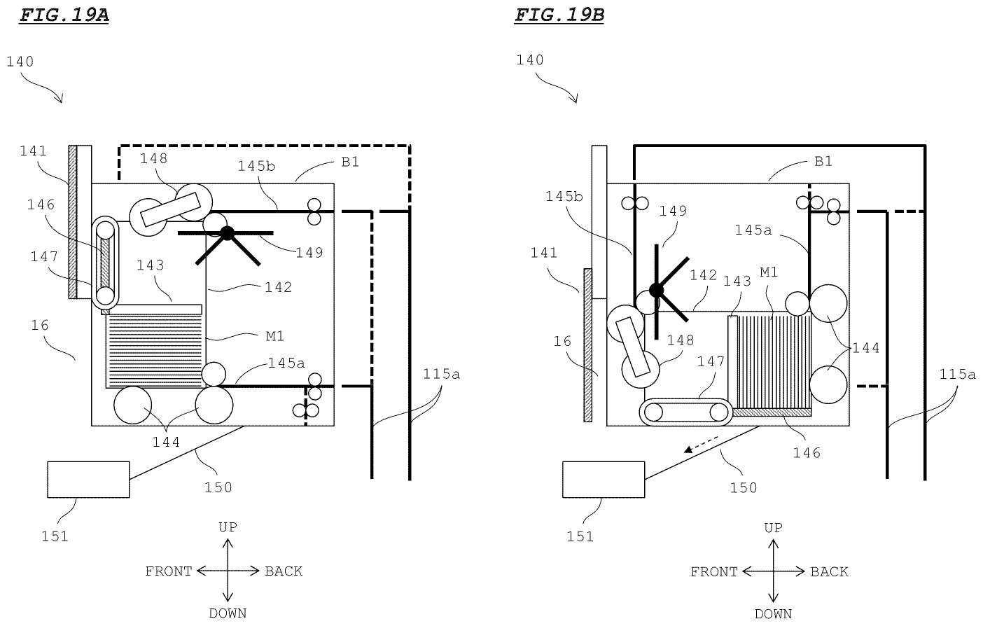

FIG. 19A is a diagram showing a configuration of a banknote depositing/dispensing unit 140 according to Modification 1.

In the configuration in FIG. 2, the inlet 12 and the outlet 13 are replaced with a single inlet/outlet 16. The depositing/dispensing unit 140 includes a shutter 141 that opens and closes the inlet/outlet 16. The depositing/dispensing unit 140 further includes a rotary block B1 that rotates in the up-down direction. The rotary block B1 includes a storage unit 142 that stores therein banknotes in a stacking direction and a pressing plate 143 that moves up and down within the storage unit 142.

The storage unit 142 is composed of a frame-like member, and the front side thereof is open such that banknotes can be inserted into and taken out from the inside of the storage unit 142 through the inlet/outlet 16. The pressing plate 143 divides the internal space of the storage unit 142 into upper and lower sections. In depositing, in the state in FIG. 19A, banknotes M1 are inserted into a region below the pressing plate 143 through the inlet/outlet 16. The inserted banknotes M1 are pressed by the pressing plate 143 and then fed out one by one to a transport path 145a by a feeding mechanism 144.

The rotary block B1 further includes a stopper 146 that holds the front side of the banknotes M1 inserted into the storage unit 142. The stopper 146 is moved up and down by a drive mechanism 147. When viewed from the front side, the stopper 146 has a quadrangular frame shape whose center is widely open. At an upper portion of the storage unit 142, a sending mechanism 148 and a stacking wheel 149 for sending the banknotes M1 from a transport path 145b to an upper region of the storage unit 142 in dispensing are placed. The sent banknotes M1 are moved to the position of the inlet/outlet 16 by the pressing plate 143 descending.

A receiving plate 150 for receiving foreign matter inserted together with the banknotes M1 is placed below the rotary block B1. Foreign matter that falls from the storage unit 142 when the rotary block B1 rotates is guided by the receiving plate 150 and discharged to a foreign matter discharge port 151. The foreign matter discharge port 151 is placed on the front surface of the housing 11 in FIG. 1.

FIG. 19B shows a state where the rotary block B1 has rotated. Before the rotary block B1 rotates, the inlet/outlet 16 is closed by the shutter 141, and the front side of the banknotes M1 is restrained by the stopper 146. In this state, the rotary block B1 is rotated to the state in FIG. 19B. If foreign matter is mixed in between the banknotes M1, the foreign matter falls under its own weight through the opening at the center of the stopper 146 due to the rotation of the rotary block B1. At this time, the banknotes M1 do not fall due to the restraint by the stopper 146. The foreign matter that has fallen is guided by the receiving plate 150 and discharged to the foreign matter discharge port 151.

In the state in FIG. 19A, a transport path 115a of the transport unit 115 is connected to the transport paths 145a and 145b in the rotary block B1 as shown by solid lines. In the state in FIG. 19B, the transport path 115a of the transport unit 115 is connected to the transport paths 145a and 145b in the rotary block B1 as shown by solid lines. In each of the states in FIGS. 19A and 19B, the banknotes M1 are transported to and from the storage unit 142 via the transport paths shown by the solid lines.

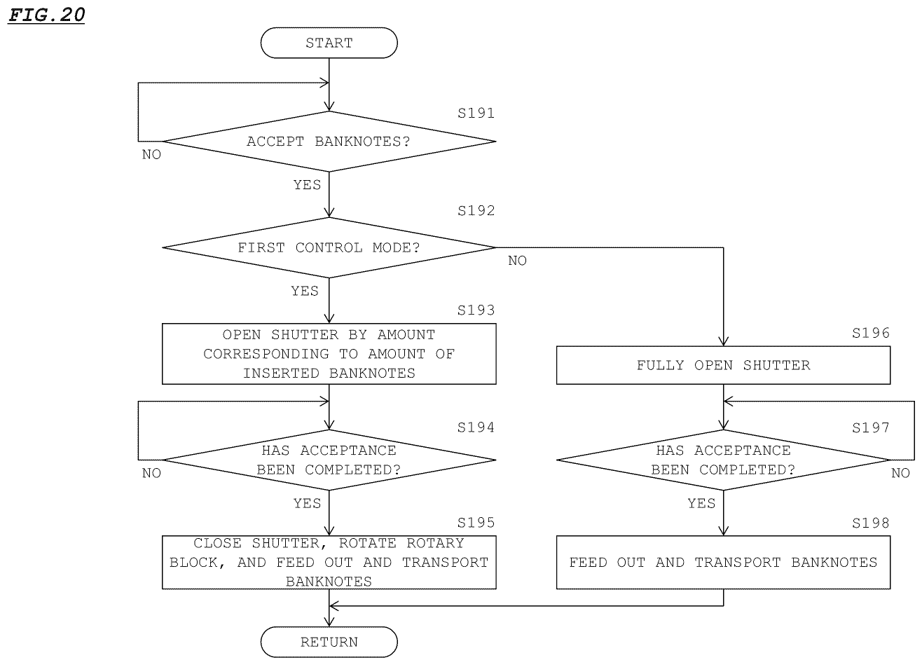

FIG. 20 is a flowchart showing an example of the process in step S17 in FIG. 5, according to Modification 1.

In this process, the opening state of the shutter 141 and the rotation state of the rotary block B1 in depositing banknotes are made different between the first control mode and the second control mode.

When a phase in which insertion of banknotes into the inlet/outlet 16 is accepted is reached by performing an operation on the input screen by the user (S191: YES), the terminal controller 211 determines whether the current control mode is the first control mode or the second control mode (S192). If the current control mode is the first control mode (S192: YES), the terminal controller 211 executes control of causing the banknote handling assembly 10 to open the shutter 141 by an amount corresponding to the amount of inserted banknotes (S193). Then, when the customer who is the user performs an input indicating that the insertion of the banknotes has been completed on the interface 51 (S194: YES), the terminal controller 211 executes control of causing the banknote handling assembly 10 to close the shutter 141, rotate the rotary block B1, and then start feeding-out and transport of the banknotes (S195).

On the other hand, if the current control mode is the second control mode (S192: NO), the terminal controller 211 executes control of causing the banknote handling assembly 10 to fully open the shutter 141 (S196). Then, when the staff member who is the user performs an input indicating the insertion of the banknotes has been completed on the interface 51 (S197: YES), the terminal controller 211 executes control of causing the banknote handling assembly 10 to start feeding-out and transport of the banknotes in that state (S198).

As described above, in the first control mode for the case of customer use, the terminal controller 211 opens the shutter 141 by an opening amount corresponding to the amount of inserted money (S193) to accept the insertion of banknotes. Accordingly, it is easier to insert banknotes in a well-aligned state, so that problems such as a banknote jam are less likely to occur in a subsequent transport operation. Meanwhile, in the second control mode for the case of staff member use, the terminal controller 211 accepts the insertion of banknotes in a state where the shutter 141 is fully opened. Accordingly, the staff member can insert banknotes more easily, so that the work efficiency of the staff member can be improved. It is also possible to add more banknotes, and work of inserting several hundred banknotes, such as loading banknotes, can be carried out. Since, usually, the staff member neatly aligns and inserts banknotes, even if the shutter 141 is fully opened as described above, problems such as a banknote jam are less likely to occur in a subsequent transport operation.

In addition, in the first control mode for the case of customer use, the terminal controller 211 closes the shutter 141, then rotates the rotary block B1, and starts transport of the banknotes (S195). Accordingly, even if foreign matter is mixed in between the inserted banknotes, the foreign matter can be prevented from being sent to the transport path 115a, and the occurrence of problems in the transport unit 115 due to foreign matter can be suppressed. Meanwhile, in the second control mode for the case of staff member use, the terminal controller 211 starts transport of the banknotes without rotating the rotary block B1 and with the shutter 141 fully opened (S198). Accordingly, the transport of the banknotes can be quickly started, so that the work efficiency of the staff member can be improved. Since the staff member usually checks that no foreign matter is mixed in between banknotes before inserting the banknotes, even if transport of the banknotes is started without rotating the rotary block B1 as described above, problems are less likely to occur in a subsequent transport operation.

The process in steps S193 to S195 can be included in step S153 in FIG. 15, and the process in steps S196 to S198 can be included in step S154 in FIG. 15.

### Modification 2

In the above embodiment, the money handling apparatus 1 includes the banknote handling assembly 10, the coin handling assembly 20, the deformed coin/commemorative coin handling assembly 30, and the unfit note handling assembly 40 as handling assemblies, but the handling assemblies included in the money handling apparatus 1 are not limited thereto.

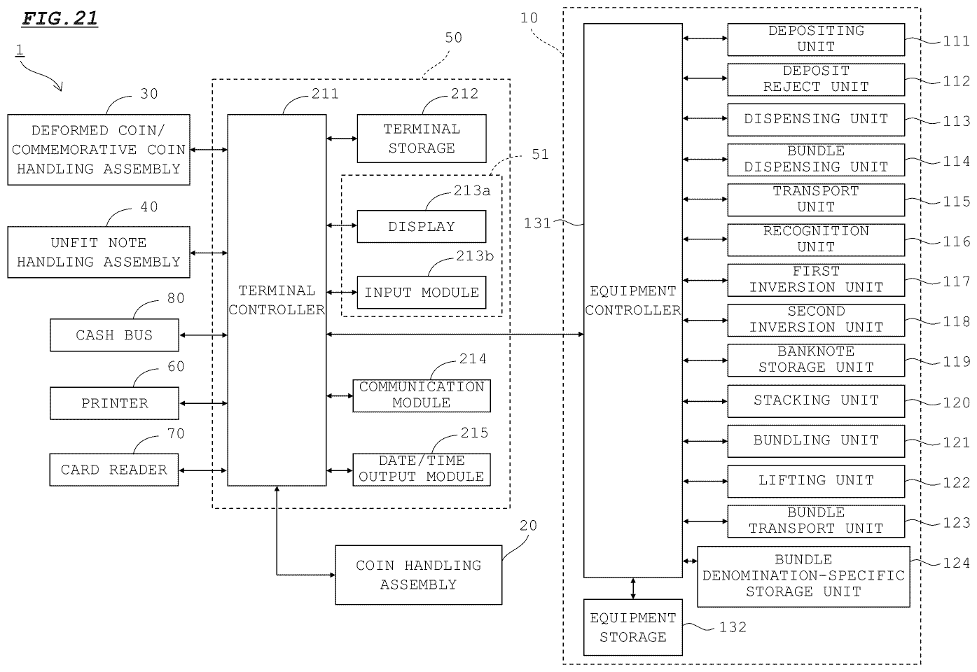

For example, as shown in FIG. 21, the money handling apparatus 1 may further include a cash bus 80 as a handling assembly. The cash bus 80 is a money handling assembly that manages a large amount of cash for each denomination. When a large amount of cash is required, the staff member of the establishment S1 accesses the cash bus 80 to dispense the cash. Also, when banknotes and coins stored in the money handling apparatus 1 become full, the staff member of the establishment S1 collects these banknotes and coins from the money handling apparatus 1 and moves these banknotes and coins to the cash bus 80.

As described above, the cash bus 80 is used to store a large amount of cash in the establishment S1, and thus it is inappropriate for customers to access the cash bus 80. Therefore, even in the case where the money handling apparatus 1 further includes the cash bus 80, access to the cash bus 80 by customers is restricted as with the deformed coin/commemorative coin handling assembly 30 and the unfit note handling assembly 40.

In this case, in the second control mode for the case of staff member use, a selection item for the cash bus 80 is included in the left region of the deposit screen 500 in FIG. 12A. By selecting this selection item, the staff member can perform depositing and dispensing with respect to the cash bus 80. Meanwhile, in the first control mode for the case of customer use, as in FIG. 12B, in the left region of the deposit screen 500, all the selection items other than the selection item 501a are grayed out so as to be unselectable. Therefore, the customer cannot select the selection item for the cash bus 80, and the use of the cash bus 80 is restricted.

As described above, the usability of the cash bus 80 is switched between the first control mode and the second control mode. Accordingly, the large amount of cash stored in the cash bus 80 can be safely managed.

### Other Modifications

In the above embodiment, the menu screens 400 and 410 in FIGS. 11A and 11B and the deposit screens 500 and 510 in FIGS. 12A and 12B are shown as examples in which the display form is made different between the first control mode and the second control mode, but the method for making the display form differ between the first control mode and the second control mode is not limited thereto. For example, the display forms of screens displayed at a lower layer than FIGS. 12A and 12B may also be made different between the first control mode and the second control mode, and the display forms of screens for dispensing and money change may also be made different between the first control mode and the second control mode.

In addition, not all the processes shown in step S153 and S154 in FIG. 15 necessarily have to be performed. For example, the process of switching the level of recognition may be omitted from steps S153 and S154. Moreover, steps S153 and S154 may further include other processes switched between the first control mode and the second control mode.

The money handling apparatus 1 does not necessarily have to include a plurality of money handling assemblies, and may, for example, be configured to include merely the banknote handling assembly 10.

In the above embodiment, as shown in FIG. 2, one money handling apparatus is configured by integrating the plurality of money handling assemblies and the operation terminal 50, but one money handling system may be configured by separately arranging a plurality of money handling assemblies and an operation terminal and connecting the money handling assemblies and the operation terminal such that the money handling assemblies and the operation terminal can communicate with each other.

In this case, in the money handling system, the banknote handling assembly 10, the coin handling assembly 20, the deformed coin/commemorative coin handling assembly 30, and the unfit note handling assembly 40 in FIG. 4 are replaced with a banknote handling device, a coin handing device, a deformed coin/commemorative coin handling device, and an unfit note handling device, respectively, and each of these devices and the separately arranged operation terminal 50 are connected so as to be able to communicate with each other. The configurations and functions of the banknote handling device, the coin handling device, the deformed coin/commemorative coin handling device, and the unfit note handling device are the same as those of the banknote handling assembly 10, the coin handling assembly 20, the deformed coin/commemorative coin handling assembly 30, and the unfit note handling assembly 40, respectively. In this case as well, the operation terminal 50 may execute the same control as in the above embodiment. In the configurations of Modifications 1 and 2 as well, similarly, the money handling apparatus 1 can be replaced with a money handling system.

In addition to the above, the embodiment of the present invention can be modified as appropriate within the scope of the claims.

What is claimed is:

1. A money handling apparatus comprising:
an information output device configured to output information by which whether a user is a customer or a staff member can be determined; and
a controller configured to selectively execute a first control mode for a case where the user is the customer and a second control mode for a case where the user is the staff member, based on the information from the information output device.

2. The money handling apparatus according to claim 1, wherein
the information output device includes an interface configured to accept an operation from the user, and
the controller determines whether the user is the customer or the staff member, based on information from the interface, and selectively executes the first control mode and the second control mode, based on a result of the determination.

3. The money handling apparatus according to claim 2, wherein the interface includes an input module configured to accept an input from the user in money handling, or a reader configured to read a storage medium of the user.

4. The money handling apparatus according to claim 1, wherein
the information output device includes a date/time output module configured to output information about a date and time, and
the controller selectively executes the first control mode and the second control mode, based on the information about the date and time outputted from the date/time output module.

5. The money handling apparatus according to claim 1, wherein
the information output device includes a camera configured to output an image of the user, and
the controller determines whether the user is the customer or the staff member, based on the image of the user outputted from the camera, and selectively executes the first control mode and the second control mode, based on a result of the determination.

6. The money handling apparatus according to claim 1, wherein the controller makes control for money handling differ between the first control mode and the second control mode.

7. The money handling apparatus according to claim 6, wherein the controller makes a money transport speed in the first control mode lower than in the second control mode.

8. The money handling apparatus according to claim 6, wherein the controller makes a level of recognition of money in the first control mode higher than in the second control mode.

9. The money handling apparatus according to claim 1, further comprising a display for outputting predetermined information, wherein
the controller makes a display form of the display differ between the first control mode and the second control mode.

10. The money handling apparatus according to claim 9, wherein the controller limits types of operation items on an acceptance screen displayed on the display in the first control mode, compared to the second control mode.

11. The money handling apparatus according to claim 1, comprising a plurality of money handling assemblies configured to perform different processes, wherein
the controller limits the money handling assemblies that can be used by the user in the first control mode, compared to the second control mode.

12. The money handling apparatus according to claim 1, further comprising a communication module configured to communicate with another device, wherein
the controller switches a mode of communication with the other device between the first control mode and the second control mode.

13. The money handling apparatus according to claim 12, wherein
in a case where an error occurs during money handling in the first control mode, the controller transmits a notification indicating the occurrence of the error to the other device without performing control for clearing the error, and
in a case where an error occurs during money handling in the second control mode, the controller performs control for clearing the error without transmitting a notification indicating the occurrence of the error to the other device.

14. A money handling system comprising:
an information output device configured to output information by which whether a user is a customer or a staff member can be determined; and
a controller configured to selectively execute a first control mode for a case where the user is the customer and a second control mode for a case where the user is the staff member, based on the information outputted by the information output device.

15. A control method in a money handling apparatus, the control method comprising:
acquiring information by which whether a user is a customer or a staff member can be determined; and
selectively executing a first control mode for a case where the user is the customer and a second control mode for a case where the user is the staff member, based on the acquired information.
